(19) United States
(12) Patent Application Publication
(10) Pub. No.: US 2013/0321069 A1
(43) Pub. Date: Dec. 5, 2013

(54) CHARGE PUMP CIRCUIT

(71) Applicant: PANASONIC COPORATION, Osaka (JP)

(72) Inventors: Hiroshi YAJIMA, Osaka (JP); Hideyuki KIHARA, Kanagawa (JP)

(21) Appl. No.: 13/941,340

(22) Filed: Jul. 12, 2013

Related U.S. Application Data
(63) Continuation of application No. PCT/JP2011/002320, filed on Apr. 20, 2011.

(30) Foreign Application Priority Data
Jan. 14, 2011 (JP) 2011-005850

(51) Int. Cl. H02M 3/07

(52) U.S. Cl. CPC H02M 3/07
USPC 327/536

(57) ABSTRACT

A charge pump circuit includes a clock signal input terminal to receive a clock signal; an inverted clock signal input terminal to receive an inverted clock signal having a phase obtained by reversing a phase of the clock signal; an output terminal for outputting an output voltage, the output voltage being generated by boosting the clock signal and the inverted clock signal; and a pump circuit including a plurality of rectifying circuits connected in series and located between the output terminal and a ground terminal and a plurality of capacitative elements respectively having first terminals respectively connected to anodes of the plurality of rectifying circuits, a second terminal of a last-stage capacitative element located on the output terminal side, the clock signal input terminal and the inverted clock signal input terminal being alternately connected to second terminals of the capacitative elements other than the last-stage capacitative element.

This is a continuation application under 35 U.S.C 111(a) of pending prior International application No. PCT/JP2011/002320, filed on Apr. 20, 2011. The disclosure of Japanese Patent Application No. 2011-005850 filed on Jan. 14, 2011 including specification, drawings and claims are incorporated herein by reference in its entirety.

### BACKGROUND OF THE INVENTION

1. Technical Field

The present invention relates to a charge pump circuit configured such that even in a case where elements having low withstand voltage are used in the charge pump circuit, the characteristic degradation or breakdown of the elements is unlikely to occur, and particularly to a charge pump circuit configured as a semiconductor integrated circuit having a SOI (Silicon On Insulator) structure or a SOS (Silicon On Sapphire) structure.

2. Description of the Related Art

To realize a plurality of functions, a semiconductor integrated circuit of recent years requires a plurality of power supplies having different voltage values (such as 1.2 V, 1.8 V, 2.8 V, −1.2 V, −1.8 V, −2.8 V, etc.). Conventionally, a plurality of power supplies are externally supplied to the semiconductor integrated circuit. However, recently, it is required to generate a plurality of power supply voltages in the semiconductor integrated circuit. In addition, since it is also required to drive the semiconductor integrated circuit by a battery, the power supply voltage of the semiconductor integrated circuit is being lowered.

As a circuit for generating a positive or negative boost voltage higher than the power supply voltage of the semiconductor integrated circuit, a charge pump circuit is mounted in the semiconductor integrated circuit. One example of the configuration of the charge pump circuit is disclosed in FIG. 1 of Japanese Laid-Open Patent Application Publication No. 2007-74840.

A charge pump circuit shown in FIG. 11 is a circuit configured such that a portion regarding the generation of the negative boost voltage is extracted from the circuit disclosed in FIG. 1 of Japanese Laid-Open Patent Application Publication No. 2007-74840. In the charge pump circuit shown in FIG. 11, diodes D91 to D95 are connected in series. A cathode of the first-stage diode D91 is maintained at a ground potential via a ground terminal 95. First terminals of capacitative elements C91 to C94 are respectively connected to connecting points 9A to 9D of the diodes D91 to D95. A clock signal input terminal 92 is connected to second terminals of the capacitative elements C91 and C93, and a clock signal CLK is input to the second terminals of the capacitative elements C91 and C93 via the clock signal input terminal 92. An inverted clock signal input terminal 93 is connected to second terminals of the capacitative elements C92 and C94, and an inverted clock signal CLKB is input to the second terminals of the capacitative elements C92 and C94 via the inverted clock signal input terminal 93. A first terminal of a capacitative element C95 and an output terminal 90 are connected to a connecting point 9E. A second terminal of the capacitative element C95 is maintained at the ground potential via a ground terminal 96.

A high level and low level of the clock signal CLK are alternately input to the clock signal input terminal 92, and a high level and low level of the inverted clock signal CLKB having a phase obtained by reversing a phase of the clock signal CLK are alternately input to the inverted clock signal input terminal 93. Each of the high levels of the clock signal CLK and the inverted clock signal CLKB is a power supply voltage VDD, and each of the low levels of the clock signal CLK and the inverted clock signal CLKB is 0 V. With this, the electric charge is transferred from the capacitative element C91 to the capacitative element C94 in order, and finally transferred to the capacitative element C95. Then, an output voltage Vout appears at the output terminal 90. In a case where each of threshold voltages of the diodes D91 to D95 is denoted by “VT”, the output voltage Vout is denoted by “−4VDD+5VT”. For example, in a case where the power supply voltage VDD is “2.8 V”, and the threshold voltage VT is “0.7 V”, the output voltage Vout becomes “−7.7 V”.

As above, the charge pump circuit shown in FIG. 11 can generate the negative boost voltage. The foregoing has explained a case where the negative boost voltage is generated as the output voltage Vout. However, in a case where the diodes D91 to D95 are connected in series such that the anodes and cathodes thereof are oppositely arranged, the positive boost voltage can be generated.

In the configuration of the charge pump circuit of FIG. 11, a voltage represented by “2VDD−VT” is applied as a reverse bias voltage to each of the diodes other than the first-stage diode D91 and the last-stage diode D95, that is, each of the second-stage diode D92, the third-stage diode D93, and the fourth-stage diode D94. An element withstand voltage of a diode is being lowered by the microfabrication of the semiconductor process of recent years, and there is a problem that when the power supply voltage VDD externally supplied to the semiconductor integrated circuit is directly applied to the charge pump circuit, the reverse bias voltage exceeds each of the element withstand voltages of the diodes, and this causes the characteristic degradation or breakdown of the elements.

For example, each of the element withstand voltages of the diodes D92, D93, D94 is “3.6 V”, each of the threshold voltages VT of the diode D92, D93, and D94 is “0.7 V”, and the power supply voltage VDD is “2.8 V”. In this case, the reverse bias voltage applied to each of the diodes D92, D93, and D94 becomes “4.9 V”, that is, exceeds each of the element withstand voltages of the diodes D92, D93, and D94.

In a case where the power supply voltage VDD is set to a low voltage such that the reverse bias voltage does not exceed each of the element withstand voltages of the diodes D92, D93, and D94, the power supply voltage VDD becomes, for example, “1.45 V”. However, in this case, there is another problem that the output voltage Vout increases from “−7.7 V” to “−2.3 V”, and this deteriorates the voltage conversion efficiency of the entire charge pump circuit.

The foregoing has explained a case where the negative boost voltage is generated. However, as with the above, in a case where the positive boost voltage is generated, and the power supply voltage VDD is directly applied to the charge pump circuit due to fear of the deterioration of the voltage conversion efficiency, there is a problem that the reverse bias voltage exceeds each of the element withstand voltages of the diodes, and this causes the characteristic degradation or breakdown of the elements.

The present invention was made to solve the above conventional problems, and an object of the present invention is to provide a charge pump circuit that is unlikely to cause the characteristic degradation or breakdown of the elements even in the case of using the semiconductor process in which the element withstand voltage is low.

### SUMMARY OF THE INVENTION

To solve the above problems, a charge pump circuit according to one aspect of the present invention includes: a clock signal input terminal to which a clock signal having a predetermined amplitude is input; an inverted clock signal input terminal to which an inverted clock signal having the predetermined amplitude and a phase obtained by reversing a phase of the clock signal is input; an output terminal from which an output voltage is output, the output voltage being generated by boosting the clock signal and the inverted clock signal in accordance with the predetermined amplitude; and a pump circuit including a plurality of rectifying circuits connected in series so as to be located between the output terminal and a ground terminal and a plurality of capacitative elements respectively having first terminals respectively connected to anodes of the plurality of rectifying circuits, a second terminal of a last-stage capacitative element located on the output terminal side among the plurality of capacitative elements being maintained at a ground potential, the clock signal input terminal and the inverted clock signal input terminal being alternately connected to second terminals of the capacitative elements other than the last-stage capacitative element, wherein each of the rectifying circuits other than a first-stage rectifying circuit and a last-stage rectifying circuit among the plurality of rectifying circuits is configured such that at least two diodes are connected in series in a state where an anode of each diode is arranged on the output terminal side, and a cathode of each diode is arranged on the ground terminal side.

According to this configuration, the terminal voltage (reverse bias voltage) applied to each of the rectifying circuits other than the first-stage and last-stage rectifying circuits is divided between at least two diodes, and the divided voltage is then applied to each diode. As a result, it is possible to provide the charge pump circuit that is unlikely to cause the characteristic degradation or breakdown of the elements even in the case of using the semiconductor process in which the element withstand voltage is low.

In the above charge pump circuit, the diodes may be diode-connected MOS transistors.

According to this configuration, in a case where the threshold voltage of the diode-connected MOS transistor is lower than that of the diode element, a higher output voltage can be obtained from the output terminal. As a result, the voltage conversion efficiency can be improved.

In the above charge pump circuit, the at least two diodes may be a first diode-connected MOS transistor arranged on the ground terminal side and a second diode-connected MOS transistor arranged on the output terminal side, and the charge pump circuit may further include: a NMOS transistor connected in parallel to the first diode-connected MOS transistor; and a PMOS transistor connected in parallel to the second diode-connected MOS transistor, wherein: the NMOS transistor may be configured such that a gate thereof is connected to an anode of the second diode-connected MOS transistor, a drain thereof is connected to an anode of the first diode-connected MOS transistor, and a source thereof is connected to a cathode of the first diode-connected MOS transistor; and the PMOS transistor may be configured such that a gate thereof is connected to the cathode of the first diode-connected MOS transistor, a drain thereof is connected to a cathode of the second diode-connected MOS transistor, and a source thereof is connected to the anode of the second diode-connected MOS transistor.

According to this configuration, in a case where the terminal voltage (reverse bias voltage) in which the cathode potential is higher than the anode potential is applied to each of the rectifying circuits other than the first-stage and last-stage rectifying circuits, the reverse bias is applied to between the gate and source of the NMOS transistor, so that the NMOS transistor becomes an off state, and similarly, the reverse bias is applied to between the source and gate of the PMOS transistor, so that the PMOS transistor becomes the off state. At this time, the terminal voltage of the rectifying circuit is divided between two diode-connected NMOS transistors, so that the reverse bias voltage applied to each of the diode-connected NMOS transistors becomes low. As a result, the characteristic degradation or breakdown of the elements is unlikely to occur even in the case of using the semiconductor process in which the element withstand voltage is low.

In contrast, in a case where the terminal voltage (forward bias voltage) in which the anode potential is higher than the cathode potential is applied to each of the rectifying circuits other than the first-stage and last stage rectifying circuits, the forward bias is applied to between the gate and source of the NMOS transistor, so that the NMOS transistor becomes an on state, and similarly, the forward bias is applied to between the source and gate of the PMOS transistor, so that the PMOS transistor becomes the on state. Here, the terminal voltage of each of the rectifying circuits other than the first-stage and last stage rectifying circuits becomes a sum of the voltage between the source and drain of the PMOS transistor and the voltage between the drain and source of the NMOS transistor. This value is substantially equal to the threshold voltage of one diode-connected NMOS transistor. Therefore, the forward bias voltage applied to each of the rectifying circuits other than the first-stage and last stage rectifying circuits can be lowered.

In the above charge pump circuit, the at least two diodes may be a first diode-connected MOS transistor arranged on the ground terminal side and a second diode-connected MOS transistor arranged on the output terminal side, and the charge pump circuit may further include a NMOS transistor connected in parallel to the first diode-connected MOS transistor, wherein the NMOS transistor may be configured such that a gate thereof is connected to an anode of the second diode-connected MOS transistor, a drain thereof is connected to an anode of the first diode-connected MOS transistor, and a source thereof is connected to a cathode of the first diode-connected MOS transistor.

According to this configuration, the same effects as above can be obtained.

In the above charge pump circuit, the at least two diodes may be a first diode-connected MOS transistor arranged on the ground terminal side and a second diode-connected MOS transistor arranged on the output terminal side, and the charge pump circuit may further include a PMOS transistor connected in parallel to the second diode-connected MOS transistor, wherein the PMOS transistor may be configured such that a gate thereof is connected to a cathode of the first diode-connected MOS transistor, a drain thereof is connected to a cathode of the second diode-connected MOS transistor, and a source thereof is connected to an anode of the second diode-connected MOS transistor.

According to this configuration, the same effects as above can be obtained.

In the above charge pump circuit, the at least two diodes may be a first diode-connected MOS transistor arranged on the ground terminal side and a second diode-connected MOS transistor arranged on the output terminal side, and the charge pump circuit may further include: a first PMOS transistor connected in parallel to the first diode-connected MOS transistor; and a second PMOS transistor connected in parallel to the second diode-connected MOS transistor, wherein: the first PMOS transistor may be configured such that a gate thereof is connected to a cathode of the first diode-connected MOS transistor, a drain thereof is connected to the cathode of the first diode-connected MOS transistor, and a source thereof is connected to an anode of the first diode-connected MOS transistor; and the second PMOS transistor may be configured such that a gate thereof is connected the cathode of the first diode-connected MOS transistor, a drain thereof is connected to a cathode of the second diode-connected MOS transistor, and a source thereof is connected to an anode of the second diode-connected MOS transistor.

According to this configuration, the same effects as above can be obtained.

In the above charge pump circuit, the at least two diodes may be a first diode-connected MOS transistor arranged on the ground terminal side and a second diode-connected MOS transistor arranged on the output terminal side, and the charge pump circuit may further include: a first NMOS transistor connected in parallel to the first diode-connected MOS transistor; and a second NMOS transistor connected in parallel to the second diode-connected MOS transistor, wherein: the first NMOS transistor may be configured such that a gate thereof is connected to an anode of the second diode-connected MOS transistor, a drain thereof is connected to an anode of the first diode-connected MOS transistor, and a source thereof is connected to a cathode of the first diode-connected MOS transistor; and the second NMOS transistor may be configured such that a gate thereof is connected to the anode of the second diode-connected MOS transistor, a drain thereof is connected to the anode of the second diode-connected MOS transistor, and a source thereof is connected to a cathode of the second diode-connected MOS transistor.

According to this configuration, the same effects as above can be obtained.

In the above charge pump circuit, the at least two diodes may be a first diode-connected MOS transistor arranged on the ground terminal side and a second diode-connected MOS transistor arranged on the output terminal side, and the charge pump circuit may further include: a NMOS transistor connected in parallel to the first diode-connected MOS transistor; and a PMOS transistor connected in parallel to the second diode-connected MOS transistor, wherein: the NMOS transistor may be configured such that a gate and drain thereof are connected to an anode of the first diode-connected MOS transistor, and a source thereof is connected to a cathode of the first diode-connected MOS transistor; and the PMOS transistor may be configured such that a gate and source thereof are connected to a cathode of the second diode-connected MOS transistor, and a source thereof is connected to the anode of the first diode-connected MOS transistor.

According to this configuration, the same effects as above can be obtained.

In the above charge pump circuit, the at least two diodes may be configured such that a plurality of rectifying circuits, each constituted by the two diode-connected MOS transistors connected in series, are connected, among the plurality of rectifying circuits, each of the first-stage rectifying circuit and the last-stage rectifying circuit may be constituted by the two diode-connected MOS transistors connected in series, and the NMOS transistor or the PMOS transistor may be connected in parallel to each of the diode-connected MOS transistors.

According to this configuration, the terminal voltage applied to between the cathode and anode of each of the rectifying circuits other than the first-stage and last-stage rectifying circuits is divided between at least two diode-connected MOS transistors constituting the plurality of rectifying circuits. Further, the terminal voltage applied to between the cathode and anode of each of the first-stage and last stage rectifying circuits is divided between at least two diode-connected MOS transistors. Therefore, the application of a higher reverse bias voltage can be realized.

In the above charge pump circuit, the charge pump circuit may be integrated on a single substrate having a silicon on insulator (SOI) structure or a silicon on sapphire (SOS) structure.

According to this configuration, by utilizing a characteristic of threshold-voltage reduction tendency of the semiconductor integrated circuit configured on the substrate having the SOI structure or the SOS structure, the output voltage output from the output terminal can be made higher. Thus, the voltage conversion efficiency can be improved.

To solve the above problems, a switch device according to another aspect of the present invention includes: the above charge pump circuit; an oscillator configured to generate by oscillation the clock signal and the inverted clock signal that are respectively input to the clock signal input terminal and inverted clock signal input terminal of the charge pump circuit; a switch including a plurality of switch input terminals and a plurality of switch output terminals and configured to realize a conducting state between any of the switch input terminals and any of the switch output terminals; a decoder configured to receive a switch changing control signal for changing the conducting state of the switch and output a driver control signal obtained by decoding the switch changing control signal; and a driver configured to use as a power supply voltage the output voltage output from the output terminal of the charge pump circuit, receive the driver control signal from the decoder, generate based on the driver control signal a switch control signal for controlling the conducting state of the switch, and output the switch control signal, wherein the charge pump circuit, the oscillator, the decoder, the driver, and the switch are integrated on a single substrate having a silicon on insulator (SOI) structure or a silicon on sapphire (SOS) structure.

According to this configuration, it is possible to provide the switch device that is unlikely to cause the characteristic degradation or breakdown of the elements even in the case of using the semiconductor process in which the element withstand voltage is low.

The above object, other objects, features, and advantages of the present invention will be made clear by the following detailed explanation of preferred embodiments with reference to the attached drawings.

According to the present invention, it is possible to provide the charge pump circuit that is unlikely to cause the characteristic degradation or breakdown of the elements even in the case of using the semiconductor process in which the element withstand voltage is low.

### BRIEF DESCRIPTION OF THE DRAWINGS

FIG. 1 is a circuit diagram showing a configuration example of a charge pump circuit according to Embodiment 1 of the present invention.

FIG. 2 is a circuit diagram showing a configuration example of a charge pump circuit according to Embodiment 2 of the present invention.

FIG. 3 is a circuit diagram showing a configuration example of a rectifying circuit according to Embodiment 3 of the present invention.

FIG. 4 is a circuit diagram showing a configuration example of the rectifying circuit according to Embodiment 4 of the present invention.

FIG. 5 is a circuit diagram showing a configuration example of the rectifying circuit according to Embodiment 5 of the present invention.

FIG. 6 is a circuit diagram showing a configuration example of the rectifying circuit according to Embodiment 6 of the present invention.

FIG. 7 is a circuit diagram showing a configuration example of the rectifying circuit according to Embodiment 7 of the present invention.

FIG. 8 is a circuit diagram showing a configuration example of the rectifying circuit according to Embodiment 8 of the present invention.

FIG. 9 is a circuit diagram showing a configuration example of the rectifying circuit according to Embodiment 9 of the present invention.

FIG. 10 is a diagram showing the configuration of a switch device according to Embodiment 10 of the present invention.

FIG. 11 is a circuit diagram showing the configuration of a conventional charge pump circuit.

### DESCRIPTION OF THE PREFERRED EMBODIMENTS

Hereinafter, preferred embodiments of the present invention will be explained in reference to the drawings. In the following explanations and drawings, the same reference signs are used for the same or corresponding components, and a repetition of the same explanation is avoided.

### Embodiment 1

### Configuration of Charge Pump Circuit

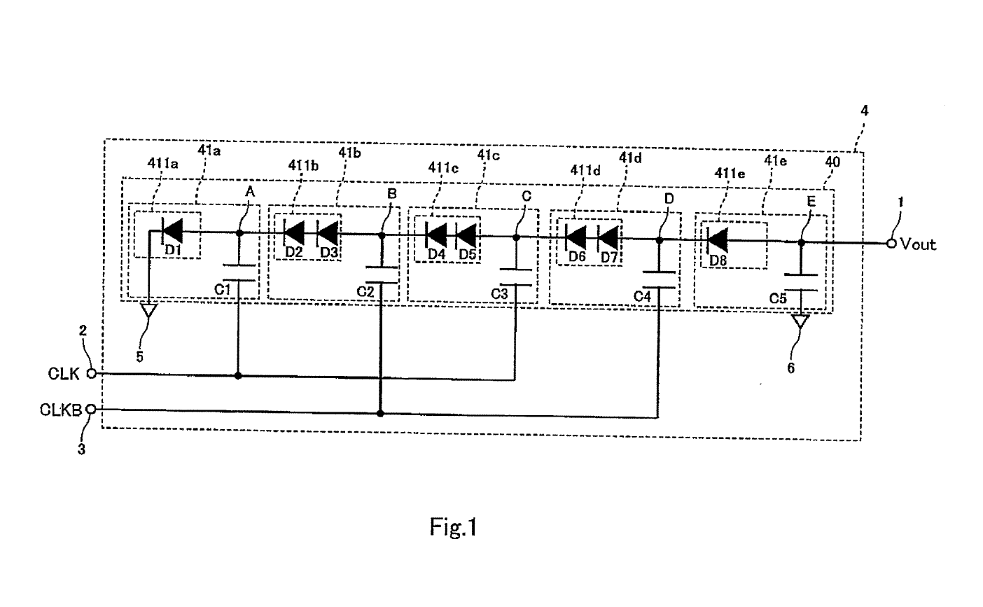

FIG. 1 is a circuit diagram showing a configuration example of a charge pump circuit according to Embodiment 1 of the present invention.

A charge pump circuit 4 shown in FIG. 1 is a circuit configured to output a negative output voltage Vout having appeared at an output terminal 1. The charge pump circuit 4 is integrated on a single substrate having a SOI (Silicon On Insulator) structure or a SOS (Silicon On Sapphire) structure.

The charge pump circuit 4 includes the output terminal 1, a clock signal input terminal 2, an inverted clock signal input terminal 3, a pump circuit 40, and ground terminals 5 and 6.

The pump circuit 40 is configured such that using a so-called Dickson booster circuit as a base, a plurality of pumping packets 41 in each of which a rectifying circuit and a capacitative element are combined are connected to form plural stages. In the present embodiment, the number of stages of the pumping packets 41 is “five”.

In a first-stage pumping packet 41a, one terminal of a capacitative element C1 is connected to a node A located on an anode side of a diode element DI serving as a rectifying circuit 411a. In a last-stage pumping packet 41e, as with the pumping packet 41a, one end of a capacitative element C5 is connected to a node E located on an anode side of a diode element D8 serving as a rectifying circuit 411e.

As with the pumping packets 41a and 41e, each of pumping packets 41b to 41d is configured such that the rectifying circuit and the capacitative element are connected to each other. However, unlike each of the pumping packets 41a and 41e, the number of stages of the diode elements serving as the rectifying circuit is “two” in each of the pumping packets 41b to 41d.

In other words, in the pump circuit 40, the diode elements D1 to D8 are connected in series such that the anode of each diode is arranged on the output terminal 1 side, and a cathode of each diode is arranged on the ground terminal 5 side. One terminal of the capacitative element C1 is connected to the node A connecting the diode elements D1 and D2. One terminal of a capacitative element C2 is connected to a node B connecting the diode elements D3 and D4. One terminal of a capacitative element C3 is connected to a node C connecting the diode elements D5 and D6. One terminal of a capacitative element C4 is connected to a node D connecting the diode elements D7 and D8. One terminal of the capacitative element C5 is connected to the anode side of the last-stage diode element D8.

The cathode of the diode element D1 of the first-stage pumping packet 41a is connected to the ground terminal 5, and the anode of the diode element D8 of the last-stage pumping packet 41e is connected to the output terminal 1. The clock signal input terminal 2 is connected to the other terminals of the capacitative elements C1 and C3 of the odd-stage pumping packets 41a and 41c, and a clock signal CLK is input through the clock signal input terminal 2 to the other terminals of the capacitative elements C1 and C3 of the odd-stage pumping packets 41a and 41c. The inverted clock signal input terminal 3 is connected to the other terminals of the capacitative elements C2 and C4 of the even-stage pumping packets 41b and 41d, and an inverted clock signal CLKB is input through the inverted clock signal input terminal 3 to the other terminals of the capacitative elements C2 and C4 of the even-stage pumping packets 41b and 41d. To be specific, when the clock signal CLK input to the other terminals of the capacitative elements C1 and C3 is a high level, the inverted clock signal CLKB input to the other terminals of the capacitative elements C2 and C4 is a low level. In contrast, when the clock signal CLK input to the other terminals of the capacitative elements C1 and C3 is the low level, the inverted clock signal CLKB input to the other terminals of the capacitative elements C2 and C4 is the high level. The other terminal of the capacitative element C5 of the last-stage pumping packet 41e is connected to the ground terminal 6.

### Operations of Charge Pump Circuit

The outline of the operations of the charge pump circuit 4 will be explained.

The clock signal CLK is input to the other terminals of the capacitative elements C1 and C3 of the odd-stage pumping packets 41a and 41c except for the last-stage pumping packet 41e, and the inverted clock signal CLKB is input to the other terminals of the capacitative elements C2 and C4 of the even-stage pumping packets 41b and 41d. With this, the pump circuit 40 repeatedly performs charge or discharge of the capacitative elements C1 to C4 for each clock cycle of the clock signal CLK or the inverted clock signal CLKB and outputs from the output terminal 1 a voltage obtained by multiplying the amplitude of the clock signal CLK or the inverted clock signal CLKB by a number corresponding to the number of stages of the pumping packets 41.

Here, the number of stages of the pumping packets 41 constituting the pump circuit 40 is denoted by “M”, an amplitude voltage of the clock signal CLK or the inverted clock signal CLKB input to the other terminals of the capacitative elements of the pumping packets 41 is denoted by “VDD”, and a forward threshold voltage of each of the diodes of the pumping packets 41 is denoted by “VT”. In this case, the output voltage Vout can be represented by a formula below.

Vout=−(M−1)×(VDD−2VT) Formula 1

For example, the VDD is “2.8 V”, the VT is “0.7 V”, and the M is “5”. In this case, “−5.6 V” can be obtained as the output voltage Vout.

Next, detailed operations of the pump circuit 40 will be explained.

First, when the clock signal CLK becomes the high level, and the inverted clock signal CLKB becomes the low level, a current flows from the clock signal input terminal 2 through the capacitative element C1 and the diode element D1 to the ground terminal 5. At this time, the voltage at the node A becomes “0 V +VT”.

In the next clock cycle, when the clock signal CLK becomes the low level, and the inverted clock signal CLKB becomes the high level, the current flows from the inverted clock signal input terminal 3 through the capacitative element C2, the diode element D3, the diode element D2, and the capacitative element C1 to the clock signal input terminal 2. At this time, the voltage at the node A becomes “−VDD+VT”, and the voltage at the node B becomes “−VDD+3VT”.

In the next clock cycle, when the clock signal CLK becomes the high level, and the inverted clock signal CLKB becomes the low level, the current flows from the clock signal input terminal 2 through the capacitative element C3, the diode element D5, the diode element D4, and the capacitative element C2 to the inverted clock signal input terminal 3. At this time, the voltage at the node B becomes “−2VDD+3VT”, and the voltage at the node C becomes “−2VDD+5VT”.

In the next clock cycle, when the clock signal CLK becomes the low level, and the inverted clock signal CLKB becomes the high level, the current flows from the inverted clock signal input terminal 3 through the capacitative element C4, the diode element D7, the diode element D6, and the capacitative element C3 to the clock signal input terminal 2. At this time, the voltage at the node C becomes “−3VDD+5VT”, and the voltage at the node D becomes “−3VDD+7VT”.

In the next clock cycle, when the clock signal CLK becomes the high level, and the inverted clock signal CLKB becomes the low level, the current flows from the output terminal 1 through the diode element D8 and the capacitative element C4 to the inverted clock signal input terminal 3. At this time, the voltage at the node D becomes “−4VDD+7VT”, and the voltage at the node E (that is, the output voltage Vout at the output terminal 1) becomes “−4VDD+8VT”.

As above, finally, the negative output voltage Vout of “−4(VDD−2VT)” obtained by Formula 1 appears at the output terminal 1.

### Dividing of Terminal Voltage of Rectifying Circuit

First, the following will focus on terminal voltages applied to the rectifying circuits 411a to 411e.

The terminal voltage applied to the rectifying circuit 411a is a potential difference between the ground terminal 5 and the node A. When the clock signal CLK is the high level, and the inverted clock signal CLKB is the low level, the potential difference between the ground terminal 5 and the node A becomes “VT” that is the forward threshold voltage of the diode element DL When the clock signal CLK is the low level, and the inverted clock signal CLKB is the high level, the potential difference between the ground terminal 5 and the node A becomes “−VDD+VT” that is a reverse bias voltage of the diode element D1.

The terminal voltage applied to the rectifying circuit 411b is a potential difference between the nodes A and B. When the clock signal CLK is the high level, and the inverted clock signal CLKB is the low level, the potential difference between the node A and the node B becomes “2VDD−2VT” that is the reverse bias voltage of both the diode elements D2 and D3. When the clock signal CLK is the low level, and the inverted clock signal CLKB is the high level, the potential difference between the nodes A and B becomes “2VT” that is a sum of the forward threshold voltages of the diode elements D2 and D3.

The terminal voltage applied to the rectifying circuit 411c is a potential difference between the nodes B and C. When the clock signal CLK is the high level, and the inverted clock signal CLKB is the low level, the potential difference between the node B and the node C becomes “2VT” that is a sum of the forward threshold voltages of the diode elements D4 and D5. When the clock signal CLK is the low level, and the inverted clock signal CLKB is the high level, the potential difference between the nodes B and C becomes “2VDD−2VT” that is the reverse bias voltage of both the diode elements D4 and D5.

The terminal voltage applied to the rectifying circuit 411d is a potential difference between the nodes C and D. When the clock signal CLK is the high level, and the inverted clock signal CLKB is the low level, the potential difference between the nodes C and D becomes “2VDD−2VT” that is the reverse bias voltage of both the diode elements D6 and D7. When the clock signal CLK is the low level, and the inverted clock signal CLKB is the high level, the potential difference between the nodes C and D becomes “2VT” that is a sum of the forward threshold voltages of the diode elements D6 and D7.

The terminal voltage applied to the rectifying circuit 411e is a potential difference between the nodes D and E. When the clock signal CLK is the high level, and the inverted clock signal CLKB is the low level, the potential difference between the nodes D and E becomes “VT” that is the forward threshold voltage of the diode element D8. In contrast, when the clock signal CLK is the low level, and the inverted clock signal CLKB is the high level, the potential difference between the nodes D and E becomes “VDD−VT” that is the reverse bias voltage of the diode element D8.

Next, the following will focus on the reverse bias voltages of the diode elements constituting the second-stage rectifying circuit 411b, the third-stage rectifying circuit 411c, and the fourth-stage rectifying circuit 411d.

The reverse bias voltage applied to each of the second-stage rectifying circuit 411b, the third-stage rectifying circuit 411c, and the fourth-stage rectifying circuit 411d is “2VDD−2VT”. For example, the diode elements D2 and D3 are the same as each other, the diode elements D4 and D5 are the same as each other, and the diode elements D6 and D7 are the same as each other. In this case, the reverse bias voltage “2VDD−2VT” is equally divided between two diode elements. Therefore, the reverse bias voltage applied to each of the diode elements D2 to D7 becomes “VDD−VT”.

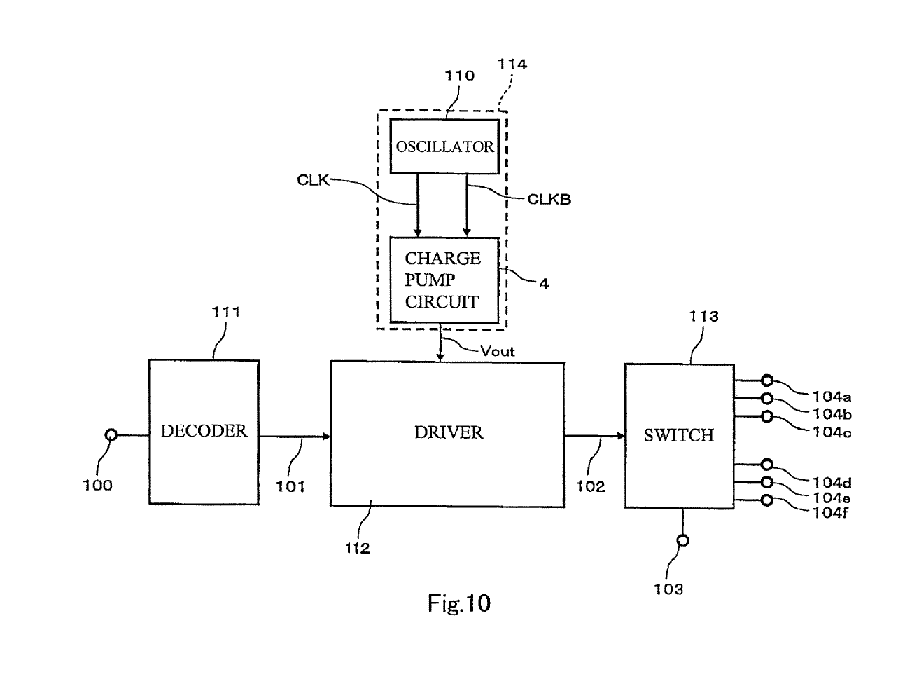

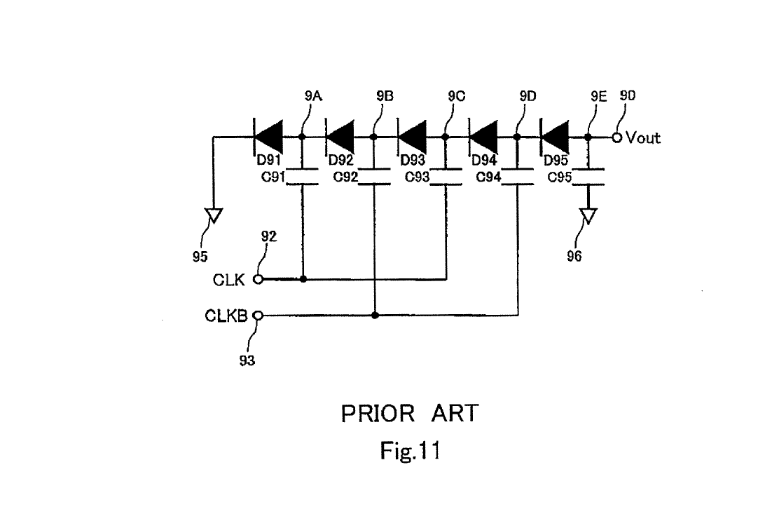

For example, the VDD is “2.8 V”, and the VT is “0.7 V”. In this case, the reverse bias voltage applied to each of the diode elements D2 to D7 becomes “2.1 V (=2.8 V−0.7 V)”. However, in the charge pump circuit of FIG. 10, the reverse bias voltage applied to each of the diode elements D2 to D4 is “4.9 V (=2.8 V×2−0.7 V)”. In the charge pump circuit of FIG. 10, in a case where the withstand voltage of the diode element is “3.6 V”, the reverse bias voltage applied to each of the second-stage diode element D92, the third-stage diode element D93, and the fourth-stage diode element D94 exceeds the withstand voltage of the diode element. However, in the charge pump circuit 4 according to Embodiment 1, the reverse bias voltage applied to each of the diode elements D2 to D7 becomes “2.1 V (=2.8 V−0.7 V)”, that is, does not exceed “3.6 V” that is the withstand voltage of the diode element.

Therefore, the present embodiment can realize the charge pump circuit that is unlikely to cause the characteristic degradation or breakdown of the elements even in the case of using the semiconductor process in which the element withstand voltage is low.

### Modification Example

In the configuration of FIG. 1, the number of stages of the pumping packets 41 is five. However, the number of stages of the pumping packets 41 depends on a predetermined output voltage Vout and is not limited to “five”.

In the configuration of FIG. 1, the number of stages of the diode elements constituting each of the rectifying circuit 411a of the first-stage pumping packet 41a and the rectifying circuit 411e of the last-stage pumping packet 41e is “one” but may be “two” as with the rectifying circuits 411b to 411d. To be specific, the number of stages of the diode elements constituting each of the rectifying circuit 411a of the first-stage pumping packet 41a and the rectifying circuit 411e of the last-stage pumping packet 41e may be at least one. With this, in each of the rectifying circuit 411a of the first-stage pumping packet 41a and the rectifying circuit 411e of the last-stage pumping packet 41e, the forward bias voltage can be divided between two diode elements, so that the rectifying circuits 411a and 411e can deal with the increase in the power supply voltage VDD.

The foregoing has explained the charge pump circuit configured to generate the negative output voltage Vout. However, even in the case of the charge pump circuit configured to generate the positive output voltage Vout, the same effects as above can be obtained. Therefore, in order that a direction from the ground terminal 5 toward the output terminal 1 becomes the forward direction, the pump circuit 40 shown in FIG. 1 may be configured such that the diode elements D1 to D8 are connected in series. The charge pump circuit 4 including the pump circuit 40 of the present configuration and the other components shown in FIG. 1 can generate the positive output voltage Vout.

### Embodiment 2

### Configuration of Charge Pump Circuit

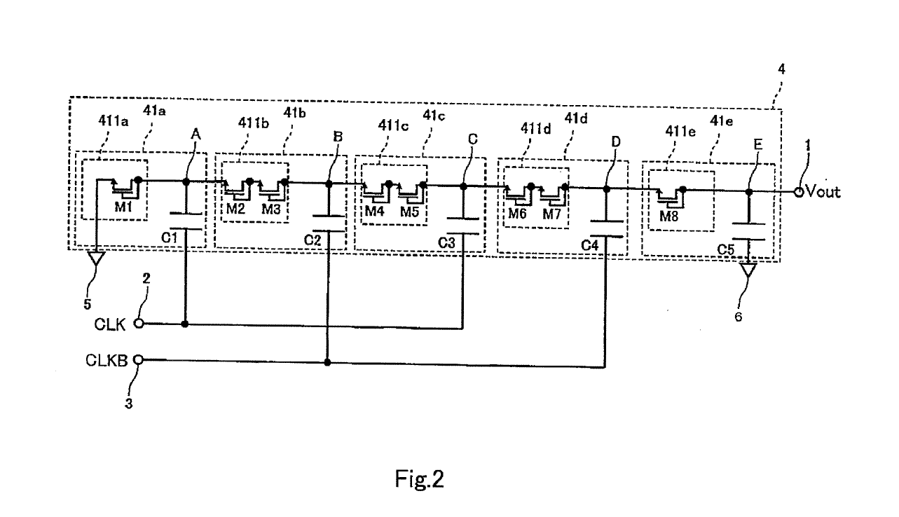

FIG. 2 is a circuit diagram showing a configuration example of the charge pump circuit according to Embodiment 2 of the present invention. The rectifying circuits 411a to 411e shown in FIG. 2 are configured such that the diode elements D1 to D8 of the rectifying circuits 411a to 411e shown in FIG. 1 are replaced with diode-connected MOS transistors (Metal-Oxide-Semiconductor transistors) M1 to M8 in each of which a gate is connected to a drain.

When the threshold voltage VT of each of the diode-connected MOS transistors M1 to M8 of the rectifying circuits 411a to 411e shown in FIG. 2 is lower than the threshold voltage VT of each of the diode elements D1 to D8 of the rectifying circuits 411a to 411e shown in FIG. 1, the output voltage Vout higher than the output voltage Vout shown in FIG. 1 can be obtained.

For example, the VDD is “2.8 V”, the VT is “0.5 V”, and the M is “5”. In this case, “−7.2 V” can be obtained as the output voltage Vout represented by Formula 1. The reverse bias voltage applied to each of the diode-connected MOS transistors M1 to M8 becomes “2.3 V”. For example, in a case where the element withstand voltage of a typical transistor in which the power supply voltage VDD is “2.8 V” is “3.6 V”, the reverse bias voltage applied to each of the diode-connected MOS transistors M1 to M8 does not exceed the element withstand voltage.

If the threshold voltage VT of each of the diode-connected MOS transistors M1 to M8 can be set to be lower than “0.5 V”, a voltage higher than “−7.2 V” can be obtained as the output voltage Vout.

As with the configuration shown in FIG. 1, by the configuration shown in FIG. 2, it is possible to realize the charge pump circuit that is unlikely to cause the characteristic degradation or breakdown of the elements even in the case of using the semiconductor process in which the element withstand voltage is low.

### Modification Example

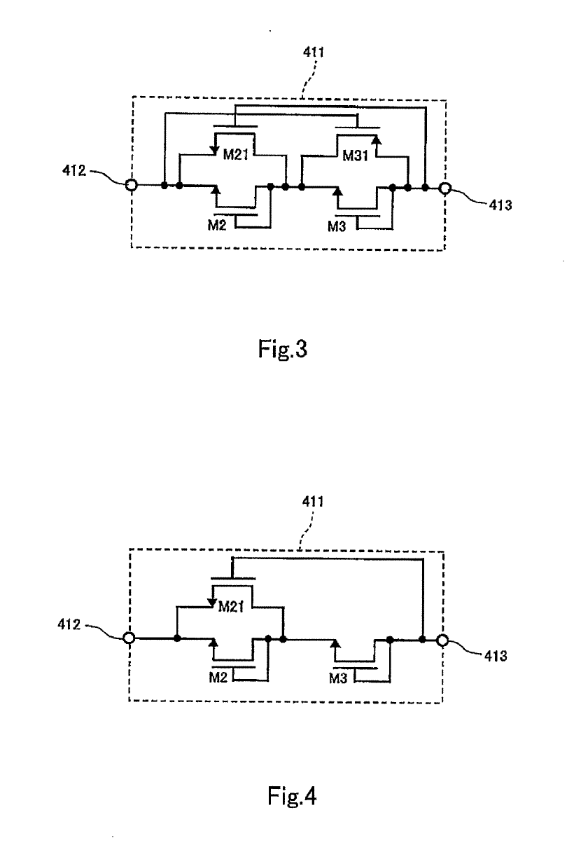

The same modification example as Embodiment 1 may be made. For example, the diode-connected MOS transistor is constituted by a NMOS transistor (Negative-channel Metal-Oxide-Semiconductor transistor) in FIG. 2 but may be constituted by a PMOS transistor (Positive-channel Metal-Oxide-Semiconductor transistor). The configurations of the rectifying circuits 411 of the charge pump circuit 4 shown in FIG. 2 may be the configurations of the rectifying circuits 411 shown in FIGS. 3 to 9 described below. By inverting and connecting an anode terminal 413 and a cathode terminal 412, the charge pump circuit 4 shown in FIG. 2 can generate the positive output voltage Vout.

### Embodiment 3

FIG. 3 is a circuit diagram showing a configuration example of the rectifying circuit 411 according to Embodiment 3 of the present invention. The present embodiment is configured such that each of the second-stage rectifying circuit 411b, the third-stage rectifying circuit 411c, and the fourth-stage rectifying circuit 411d shown in FIG. 2 is replaced with the rectifying circuit 411 shown in FIG. 3. The configuration of the rectifying circuit 411 shown in FIG. 3 will be explained in detail.

The diode-connected NMOS transistors M2 and M3, in each of which the gate is connected to the drain, are connected in series. The anode terminal 413 of the rectifying circuit 411 is connected to the drain of the diode-connected NMOS transistor M3, and the cathode terminal 412 of the rectifying circuit 411 is connected to a source of the diode-connected NMOS transistor M2.

A NMOS transistor M21 is connected in parallel to the diode-connected NMOS transistor M2. The source of the NMOS transistor M21 is connected to the cathode of the diode-connected NMOS transistor M2, and the drain of the NMOS transistor M21 is connected to the anode of the diode-connected NMOS transistor M2. The gate of the NMOS transistor M21 is connected to the anode terminal 413 of the rectifying circuit 411.

A PMOS transistor M31 is connected in parallel to the diode-connected NMOS transistor M3. The source of the PMOS transistor M31 is connected to the anode of the diode-connected NMOS transistor M3, and the drain of the PMOS transistor M31 is connected to the cathode of the diode-connected NMOS transistor M3. The gate of the PMOS transistor M31 is connected to the cathode terminal 412 of the rectifying circuit 411.

The diode-connected NMOS transistors M2 and M3 are not limited to the NMOS transistors and may be constituted by the PMOS transistors.

Operations of the rectifying circuit 411 shown in FIG. 3 will be explained.

In a case where the terminal voltage (reverse bias voltage) in which the potential of the anode terminal 413 is lower than the potential of the cathode terminal 412 is applied to the rectifying circuit 411, the reverse bias is applied to between the gate and source of the NMOS transistor M21, so that the NMOS transistor M21 becomes an off state, and similarly, the reverse bias is applied to between the source and gate of the PMOS transistor M31, so that the PMOS transistor M31 becomes the off state. In this case, as with the rectifying circuit 411 shown in FIG. 2, the potential difference between the anode terminal 413 and the cathode terminal 412 is divided between the diode-connected NMOS transistors M2 and M3. Thus, the reverse bias voltage applied to each of the diode-connected NMOS transistors M2 and M3 becomes substantially half the potential difference between the anode terminal 413 and the cathode terminal 412.

In contrast, in a case where the terminal voltage (forward bias voltage) in which the potential of the anode terminal 413 is higher than the potential of the cathode terminal 412 is applied to the rectifying circuit 411, the forward bias is applied to between the gate and source of the NMOS transistor M21, so that the NMOS transistor M21 becomes an on state before the diode-connected NMOS transistor M2 becomes the on state, and similarly, the forward bias is applied to between the source and gate of the PMOS transistor M31, so that the PMOS transistor M31 becomes the on state before the diode-connected NMOS transistor M3 becomes the on state.

The forward bias voltage of the rectifying circuit 411 of FIG. 2 is “2VT” that is a sum of the threshold voltages VT of the diode-connected NMOS transistors M2 and M3. The forward bias voltage of the rectifying circuit 411 of FIG. 3 is a sum of the voltage between the source and drain of the PMOS transistor M31 and the voltage between the drain and source of the NMOS transistor M21. This value is substantially equal to the threshold voltage VT of the diode-connected NMOS transistor M3. Therefore, the forward bias voltage that is the potential difference between the anode terminal 413 and the cathode terminal 412 can be set to be lower than the forward bias voltage of the rectifying circuit 411 of FIG. 2.

In a case where the rectifying circuit 411 shown in FIG. 2 is replaced with the rectifying circuit 411 shown in FIG. 3, the output voltage Vout of the charge pump circuit 4 can be represented by a formula below.

Vout=−(M−1)×(VDD−VT) Formula 2

For example, the VDD is “2.8 V”, the VT is “0.5 V”, and the M is “5”. In this case, the output voltage Vout represented by Formula 2 becomes “−9.2 V”. This output voltage Vout is higher than “−7.2 V” that is the output voltage Vout of the charge pump circuit 4 according to Embodiment 2 and is also higher than “−7.7 V” that is the output voltage Vout of the charge pump circuit shown in FIG. 10.

If the threshold voltage VT of each of the diode-connected NMOS transistors M2 and M3 can be set to be lower than “0.5 V”, the output voltage Vout can be set to be higher than “−9.2 V”. This is advantageous for the semiconductor integrated circuit configured on the substrate of the SOI structure or SOS structure having the characteristic of threshold-voltage reduction tendency.

The reverse bias voltage applied to each of the diode-connected MOS transistors M1 to M8 becomes “2.3 V (=2.8 V−0.5 V)”. For example, in a case where the element withstand voltage of a typical transistor in which the power supply voltage VDD is “2.8 V” is “3.6 V”, the reverse bias voltage applied to each of the diode-connected MOS transistors M1 to M8 does not exceed the element withstand voltage.

Therefore, the present embodiment can realize the charge pump circuit that does not deteriorate the voltage conversion efficiency and is unlikely to cause the characteristic degradation or breakdown of the elements even in the case of using the semiconductor process in which the element withstand voltage is low. The same modification example as Embodiment 2 can be made.

### Embodiment 4

FIG. 4 is a circuit diagram showing a configuration example of the rectifying circuit 411 according to Embodiment 4 of the present invention. The present embodiment is configured such that each of the second-stage rectifying circuit 411b, the third-stage rectifying circuit 411c, and the fourth-stage rectifying circuit 411d shown in FIG. 2 is replaced with the rectifying circuit 411 shown in FIG. 4.

The configuration of the rectifying circuit 411 shown in FIG. 4 is such that the PMOS transistor M31 is omitted from the configuration of the rectifying circuit 411 of Embodiment 3 shown in FIG. 3.

The present embodiment can obtain the same effects as Embodiment 3. In addition, the same modification example as Embodiment 2 can be made.

### Embodiment 5

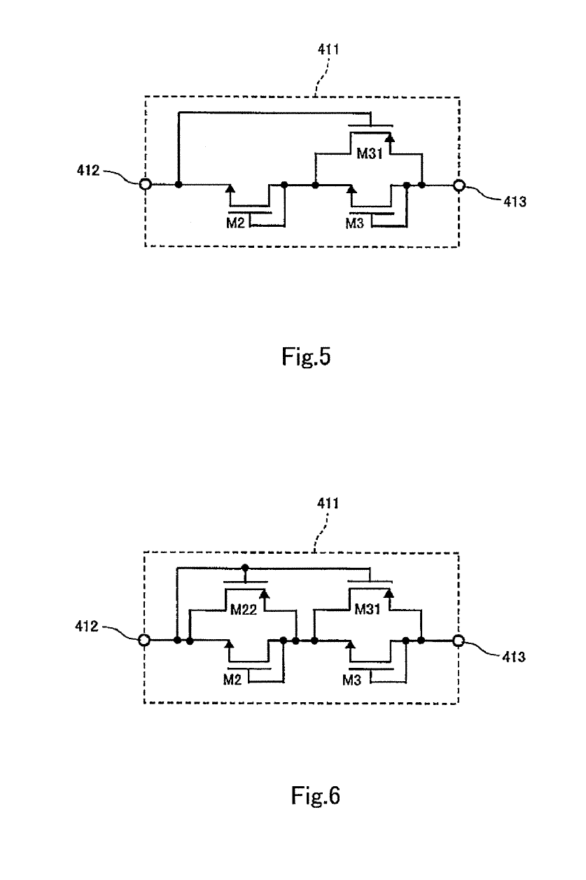

FIG. 5 is a circuit diagram showing a configuration example of the rectifying circuit 411 according to Embodiment 5 of the present invention.

The present embodiment is configured such that each of the second-stage rectifying circuit 411b, the third-stage rectifying circuit 411c, and the fourth-stage rectifying circuit 411d shown in FIG. 2 is replaced with the rectifying circuit 411 shown in FIG. 5.

The configuration of the rectifying circuit 411 shown in FIG. 5 is such that the NMOS transistor M21 is omitted from the configuration of the rectifying circuit 411 of Embodiment 3 shown in FIG. 3.

The present embodiment can obtain the same effects as Embodiment 3. The same modification example as Embodiment 2 can be made.

### Embodiment 6

FIG. 6 is a circuit diagram showing a configuration example of the rectifying circuit 411 according to Embodiment 6 of the present invention.

The present embodiment is configured such that each of the second-stage rectifying circuit 411b, the third-stage rectifying circuit 411c, and the fourth-stage rectifying circuit 411d shown in FIG. 2 is replaced with the rectifying circuit 411 shown in FIG. 6.

The configuration of the rectifying circuit 411 shown in FIG. 6 is such that in the configuration of the rectifying circuit 411 of Embodiment 3 shown in FIG. 3, the NMOS transistor M21 connected in parallel to the diode-connected NMOS transistor M2 is replaced with a PMOS transistor M22. The source of the PMOS transistor M22 is connected to the anode of the diode-connected NMOS transistor M2, and the drain of the PMOS transistor M22 is connected to the anode of the diode-connected NMOS transistor M2. The gate of the PMOS transistor M22 is connected to the cathode terminal 412 of the rectifying circuit 411.

Operations of the rectifying circuit 411 shown in FIG. 6 will be explained.

In a case where the terminal voltage (reverse bias voltage) in which the potential of the anode terminal 413 is lower than the potential of the cathode terminal 412 is applied to the rectifying circuit 411, the reverse bias is applied to between the source and gate of the PMOS transistor M22, so that the PMOS transistor M22 becomes the off state, and similarly, the reverse bias is applied to between the source and gate of the PMOS transistor M31, so that the PMOS transistor M31 becomes the off state. Therefore, in this case, as with the rectifying circuit 411 of FIG. 2, the reverse bias voltage that is the potential difference between the anode terminal 413 and the cathode terminal 412 is divided between the diode-connected NMOS transistors M2 and M3. Thus, the reverse bias voltage applied to each of the diode-connected NMOS transistors M2 and M3 becomes low.

In contrast, in a case where the terminal voltage (forward bias voltage) in which the potential of the anode terminal 413 is higher than the potential of the cathode terminal 412 is applied to the rectifying circuit 411, the forward bias is applied to between the source and gate of the PMOS transistor M31, so that the PMOS transistor M31 becomes the on state. In addition, after the PMOS transistor M31 has become the on state, the forward bias is applied to between the source and gate of the PMOS transistor M22, so that the PMOS transistor M22 becomes the on state. Therefore, the forward bias voltage that is the potential difference between the anode terminal 413 and the cathode terminal 412 becomes lower than the forward bias voltage of the rectifying circuit 411 shown in FIG. 2.

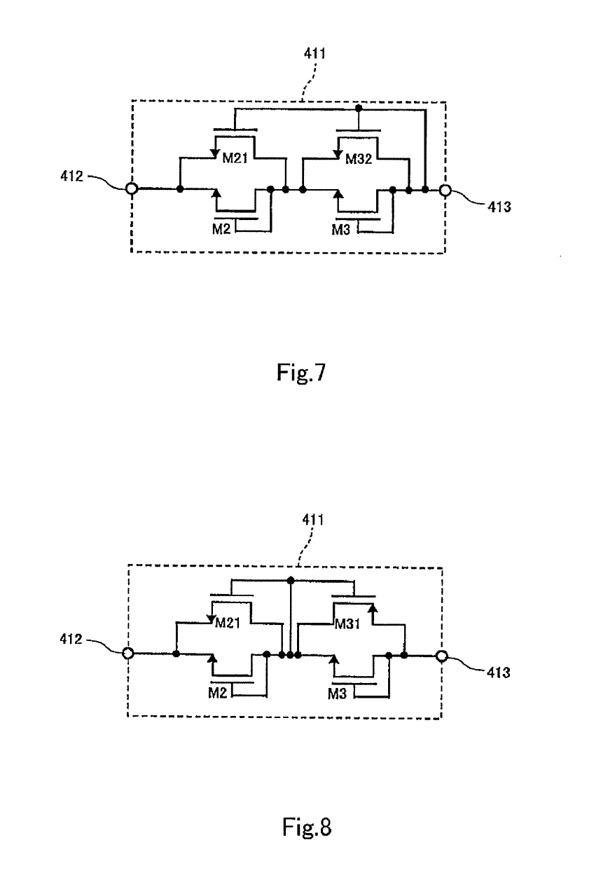

The forward bias voltage of the rectifying circuit 411 of FIG. 2 is “2VT” that is a sum of the threshold voltages VT of the diode-connected NMOS transistors M2 and M3. The forward bias voltage of the rectifying circuit 411 of FIG. 7 is a sum of the voltage between the source and drain of the PMOS transistor M22 and the voltage between the source and drain of the PMOS transistor M31. This value becomes substantially equal to the threshold voltage VT of the diode-connected NMOS transistor M3.

The present embodiment can obtain the same effects as Embodiment 3. The same modification example as Embodiment 2 can be made.

### Embodiment 7

FIG. 7 is a circuit diagram showing a configuration example of the rectifying circuit 411 according to Embodiment 7 of the present invention. The present embodiment is configured such that each of the second-stage rectifying circuit 411b, the third-stage rectifying circuit 411c, and the fourth-stage rectifying circuit 411d shown in FIG. 2 is replaced with the rectifying circuit 411 shown in FIG. 7.

The configuration of the rectifying circuit 411 shown in FIG. 7 will be explained in detail.

The configuration of the rectifying circuit 411 shown in FIG. 7 is such that in the configuration of the rectifying circuit 411 of Embodiment 3 shown in FIG. 3, the PMOS transistor M31 connected in parallel to the diode-connected NMOS transistor M3 is replaced with a NMOS transistor M32.

The source of the NMOS transistor M32 is connected to the cathode of the diode-connected NMOS transistor M3, and the drain of the NMOS transistor M32 is connected to the anode of the diode-connected NMOS transistor M3. The gate of the NMOS transistor M32 is connected to the anode terminal 413 of the rectifying circuit 411.

The present embodiment can obtain the same effects as Embodiment 3. The same modification example as Embodiment 2 can be made.

### Embodiment 8

FIG. 8 is a circuit diagram showing a configuration example of the rectifying circuit 411 according to Embodiment 8 of the present invention. The present embodiment is configured such that each of the second-stage rectifying circuit 411b, the third-stage rectifying circuit 411c, and the fourth-stage rectifying circuit 411d shown in FIG. 2 is replaced with the rectifying circuit 411 shown in FIG. 8. The configuration of the rectifying circuit 411 shown in FIG. 8 is such that in the configuration of the rectifying circuit 411 according to Embodiment 3 shown in FIG. 3, the gates of the NMOS transistor M21 and the PMOS transistor M31 are respectively connected to the drains of the NMOS transistor M21 and the PMOS transistor M31.

Operations of the rectifying circuit 411 shown in FIG. 8 will be explained. In a case where the terminal voltage (reverse bias voltage) in which the potential of the anode terminal 413 is lower than the potential of the cathode terminal 412 is applied to the rectifying circuit 411, the reverse bias is applied to between the source and gate of the NMOS transistor M21, so that the NMOS transistor M21 becomes the off state, and similarly, the reverse bias is applied to between the source and gate of the PMOS transistor M31, so that the PMOS transistor M31 becomes the off state. Therefore, in this case, as with the rectifying circuit 411 of FIG. 2, the reverse bias voltage that is the potential difference between the anode terminal 413 and the cathode terminal 412 is divided between the diode-connected NMOS transistors M2 and M3. Thus, the reverse bias voltage applied to each of the diode-connected NMOS transistors M2 and M3 becomes low.

In contrast, in a case where the terminal voltage (forward bias voltage) in which the potential of the anode terminal 413 is higher than the potential of the cathode terminal 412 is applied to the rectifying circuit 411, the forward bias is applied to between the source and gate of the PMOS transistor M31, so that the PMOS transistor M31 becomes the on state, and similarly, the forward bias is applied to between the gate and source of the NMOS transistor M21, so that the NMOS transistor M21 becomes the on state. Therefore, the forward bias voltage that is the potential difference between the anode terminal 413 and the cathode terminal 412 becomes lower than the forward bias voltage of the rectifying circuit 411 of FIG. 2.

The forward bias voltage of the rectifying circuit 411 of FIG. 2 is “2VT” that is a sum of the threshold voltages VT of the diode-connected NMOS transistors M2 and M3. The forward bias voltage of the rectifying circuit 411 of FIG. 8 is a sum of the voltage between the source and drain of the PMOS transistor M31 and the voltage between the drain and source of the NMOS transistor M21. The present embodiment can obtain the same effects as Embodiment 3. In addition, the same modification example as Embodiment 2 can be made.

### Embodiment 9

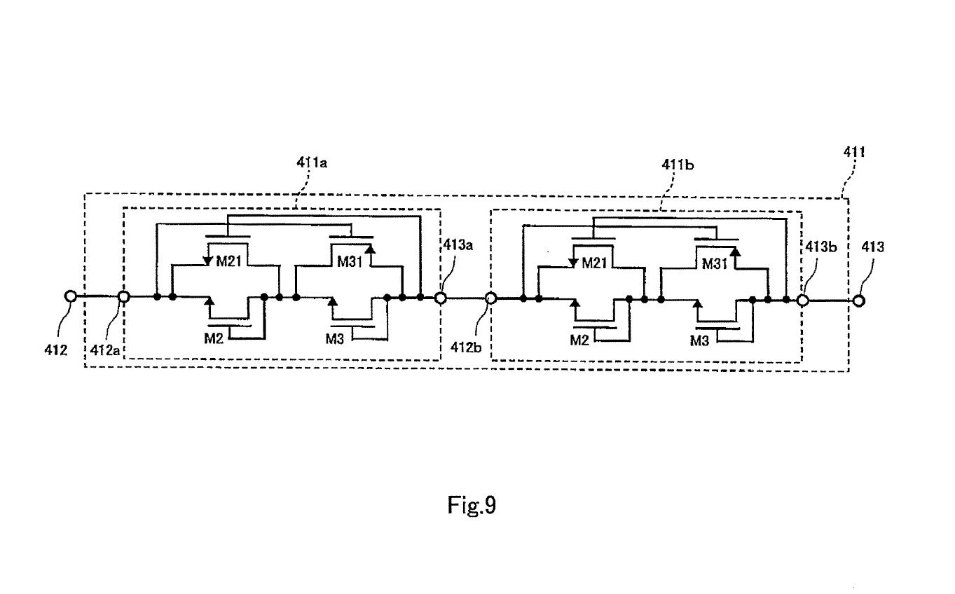

FIG. 9 is a circuit diagram showing a configuration example of the rectifying circuit 411 according to Embodiment 9 of the present invention.

The present embodiment is configured such that each of the second-stage rectifying circuit 411b, the third-stage rectifying circuit 411c, and the fourth-stage rectifying circuit 411d shown in FIG. 2 is replaced with the rectifying circuit 411 shown in FIG. 9, and each of the first-stage rectifying circuit 411a and the fifth-stage rectifying circuit 411e shown in FIG. 2 is replaced with the rectifying circuit 411 of Embodiment 3 shown in FIG. 3. To be specific, the rectifying circuit 411 shown in FIG. 9 is configured such that two rectifying circuits 411 of Embodiment 3 shown in FIG. 3 are connected in series.

An anode terminal 413a of a first-stage rectifying circuit 411a and a cathode terminal 412b of a second-stage rectifying circuit 411b are connected to each other. The cathode terminal 412 of the rectifying circuit 411 is connected to a cathode terminal 412a of the first-stage rectifying circuit 411a, and the anode terminal 413 of the rectifying circuit 411 is connected to an anode terminal 413b of the second-stage rectifying circuit 411b.

As above, in the present embodiment, since each of the second-stage rectifying circuit 411b, the third-stage rectifying circuit 411c, and the fourth-stage rectifying circuit 411d is configured by connecting two rectifying circuits 411a and 411b in series, the terminal voltage applied to between the cathode terminal 412 and anode terminal 413 of the rectifying circuit 411 is divided among four diode-connected MOS transistors. Further, since each of the first-stage rectifying circuit 411a and the fifth-stage rectifying circuit 411e is configured by connecting two diode-connected MOS transistors M2 and M3 in series, the terminal voltage applied to between the cathode terminal 412 and anode terminal 413 of the rectifying circuit 411 is divided between two diode-connected MOS transistors. Therefore, the application of the higher reverse bias voltage can be realized.

Other than the rectifying circuits 411 of Embodiment 3 shown in FIG. 3, two rectifying circuits 411 of Embodiment 4 shown in FIG. 4, two rectifying circuits 411 of Embodiment 5 shown in FIG. 5, two rectifying circuits 411 of Embodiment 6 shown in FIG. 6, two rectifying circuits 411 of Embodiment 7 shown in FIG. 7, or two rectifying circuits 411 of Embodiment 8 shown in FIG. 8 may be connected, or a plurality of rectifying circuits 411 of different embodiments may be connected. The same modification example as Embodiment 2 can be made.

### Embodiment 10

FIG. 10 is a block diagram showing the configuration of a switch device according to Embodiment 10 of the present invention.

The present embodiment is configured such that the charge pump circuit 4 according to Embodiments 1 to 9 is applied to a booster power supply of the switch device configured to switch a high frequency signal.

A switch changing control signal is externally input to the control signal input terminal 100. A decoder 111 decodes the switch changing control signal, having been input to the control signal input terminal 100, to generate a driver control signal 101. A driver 112 generates a switch control signal 102 in accordance with the driver control signal 101. In accordance with the switch control signal 102, a switch 113 realizes a conducting state between a switch input terminal 103 and any one of switch output terminals 104a to 104f. To be specific, based on the switch control signal 102, the signal input to the switch input terminal 103 is output from any one of the switch output terminals 104a to 104f.

A booster power supply 114 includes an oscillator 110 and the charge pump circuit 4.

The oscillator 110 generates by oscillation the clock signal CLK and the inverted clock signal CLKB that are used to drive the charge pump circuit 4. Then, the oscillator 110 respectively inputs the clock signal CLK and the inverted clock signal CLKB to the clock signal input terminal 2 and inverted clock signal input terminal 3 of the charge pump circuit 4.

As described in Embodiments 1 to 9, the charge pump circuit 4 outputs the positive or negative output voltage Vout having appeared at the output terminal 1. The driver 112 can use the output voltage Vout, supplied from the charge pump circuit 4, as the power supply voltage to generate the switch control signal 102 by the output voltage Vout. Since the output voltage Vout is higher than the power supply voltage applied as a power supply (not shown) of the entire switch device, the voltage of the switch control signal 102 output from the driver 112 becomes higher than the power supply voltage of the entire switch device. As a result, the characteristic improvements (low strain, low loss, and high isolation) of the switch 113 are realized.

Further, the switch device of FIG. 10 is integrated on a single substrate having the SOI structure or the SOS structure. To be specific, the oscillator 110, the charge pump circuit 4, the decoder 111, the driver 112, and the switch 113 constituting the switch device of FIG. 10 are integrated on the single substrate having the SOI structure or the SOS structure.

As above, since the charge pump circuit 4 that is unlikely to cause the characteristic degradation and breakdown even in the case of using the semiconductor process in which the element withstand voltage is low is applied as the booster power supply of the switch device, the switch device that realizes the low strain, the low loss, and the high isolation can be obtained.

The number of switch input terminals of the switch 113 is not limited to one, and the number of switch output terminals of the switch 113 is not limited to six. The output voltage Vout of the booster power supply 114 is not limited to the negative boost voltage, and may be the positive boost voltage or both the positive boost voltage and the negative boost voltage. In other words, the output voltage Vout of the charge pump circuit 4 constituting the booster power supply 114 is not limited to the negative boost voltage, and may be the positive boost voltage or both the positive boost voltage and the negative boost voltage.

From the foregoing explanation, many modifications and other embodiments of the present invention are obvious to one skilled in the art. Therefore, the foregoing explanation should be interpreted only as an example and is provided for the purpose of teaching the best mode for carrying out the present invention to one skilled in the art. The structures and/or functional details may be substantially modified within the spirit of the present invention.

The charge pump circuit of the present invention is useful as the charge pump circuit using the semiconductor process in which the element withstand voltage is low.

1. A charge pump circuit comprising:
a clock signal input terminal to which a clock signal having a predetermined amplitude is input;
an inverted clock signal input terminal to which an inverted clock signal having the predetermined amplitude and a phase obtained by reversing a phase of the clock signal is input;
an output terminal from which an output voltage is output, the output voltage being generated by boosting the clock signal and the inverted clock signal in accordance with the predetermined amplitude; and
a pump circuit including a plurality of rectifying circuits connected in series so as to be located between the output terminal and a ground terminal and a plurality of capacitative elements respectively having first terminals respectively connected to anodes of the plurality of rectifying circuits, a second terminal of a last-stage capacitative element located on the output terminal side among the plurality of capacitative elements being maintained at a ground potential, the clock signal input terminal and the inverted clock signal input terminal being alternately connected to second terminals of the capacitative elements other than the last-stage capacitative element, wherein
each of the rectifying circuits other than a first-stage rectifying circuit and a last-stage rectifying circuit among the plurality of rectifying circuits is configured such that at least two diodes are connected in series in a state where an anode of each diode is arranged on the output terminal side, and a cathode of each diode is arranged on the ground terminal side.

2. The charge pump circuit according to claim 1, wherein the diodes are diode-connected MOS transistors.

3. The charge pump circuit according to claim 2, wherein
said at least two diodes are a first diode-connected MOS transistor arranged on the ground terminal side and a second diode-connected MOS transistor arranged on the output terminal side,
the charge pump circuit further comprising:
a NMOS transistor connected in parallel to the first diode-connected MOS transistor; and
a PMOS transistor connected in parallel to the second diode-connected MOS transistor, wherein:
the NMOS transistor is configured such that a gate thereof is connected to an anode of the second diode-connected MOS transistor, a drain thereof is connected to an anode of the first diode-connected MOS transistor, and a source thereof is connected to a cathode of the first diode-connected MOS transistor; and
the PMOS transistor is configured such that a gate thereof is connected to the cathode of the first diode-connected MOS transistor, a drain thereof is connected to a cathode of the second diode-connected MOS transistor, and a source thereof is connected to the anode of the second diode-connected MOS transistor.

4. The charge pump circuit according to claim 2, wherein
said at least two diodes are a first diode-connected MOS transistor arranged on the ground terminal side and a second diode-connected MOS transistor arranged on the output terminal side,
the charge pump circuit further comprising a NMOS transistor connected in parallel to the first diode-connected MOS transistor, wherein
the NMOS transistor is configured such that a gate thereof is connected to an anode of the second diode-connected MOS transistor, a drain thereof is connected to an anode of the first diode-connected MOS transistor, and a source thereof is connected to a cathode of the first diode-connected MOS transistor.

5. The charge pump circuit according to claim 2, wherein
said at least two diodes are a first diode-connected MOS transistor arranged on the ground terminal side and a second diode-connected MOS transistor arranged on the output terminal side,
the charge pump circuit further comprising a PMOS transistor connected in parallel to the second diode-connected MOS transistor, wherein
the PMOS transistor is configured such that a gate thereof is connected to a cathode of the first diode-connected MOS transistor, a drain thereof is connected to a cathode of the second diode-connected MOS transistor, and a source thereof is connected to an anode of the second diode-connected MOS transistor.

6. The charge pump circuit according to claim 2, wherein
said at least two diodes are a first diode-connected MOS transistor arranged on the ground terminal side and a second diode-connected MOS transistor arranged on the output terminal side,
the charge pump circuit further comprising:
a first PMOS transistor connected in parallel to the first diode-connected MOS transistor; and
a second PMOS transistor connected in parallel to the second diode-connected MOS transistor, wherein:
the first PMOS transistor is configured such that a gate thereof is connected to a cathode of the first diode-connected MOS transistor, a drain thereof is connected to the cathode of the first diode-connected MOS transistor, and a source thereof is connected to an anode of the first diode-connected MOS transistor; and
the second PMOS transistor is configured such that a gate thereof is connected the cathode of the first diode-connected MOS transistor, a drain thereof is connected to a cathode of the second diode-connected MOS transistor, and a source thereof is connected to an anode of the second diode-connected MOS transistor.

7. The charge pump circuit according to claim 2, wherein
said at least two diodes are a first diode-connected MOS transistor arranged on the ground terminal side and a second diode-connected MOS transistor arranged on the output terminal side,
the charge pump circuit further comprising:
a first NMOS transistor connected in parallel to the first diode-connected MOS transistor; and
a second NMOS transistor connected in parallel to the second diode-connected MOS transistor, wherein:
the first NMOS transistor is configured such that a gate thereof is connected to an anode of the second diode-connected MOS transistor, a drain thereof is connected to an anode of the first diode-connected MOS transistor, and a source thereof is connected to a cathode of the first diode-connected MOS transistor; and
the second NMOS transistor is configured such that a gate thereof is connected to the anode of the second diode-connected MOS transistor, a drain thereof is connected to the anode of the second diode-connected MOS transistor, and a source thereof is connected to a cathode of the second diode-connected MOS transistor.

8. The charge pump circuit according to claim 2, wherein
said at least two diodes are a first diode-connected MOS transistor arranged on the ground terminal side and a second diode-connected MOS transistor arranged on the output terminal side,
the charge pump circuit further comprising:
a NMOS transistor connected in parallel to the first diode-connected MOS transistor; and
a PMOS transistor connected in parallel to the second diode-connected MOS transistor, wherein:
the NMOS transistor is configured such that a gate and drain thereof are connected to an anode of the first diode-connected MOS transistor, and a source thereof is connected to a cathode of the first diode-connected MOS transistor; and
the PMOS transistor is configured such that a gate and source thereof are connected to a cathode of the second diode-connected MOS transistor, and a source thereof is connected to the anode of the first diode-connected MOS transistor.

9. The charge pump circuit according to claim 3, wherein:
said at least two diodes are configured such that a plurality of rectifying circuits, each constituted by the two diode-connected MOS transistors connected in series, are connected;
among the plurality of rectifying circuits, each of the first-stage rectifying circuit and the last-stage rectifying circuit is constituted by the two diode-connected MOS transistors connected in series; and
the NMOS transistor or the PMOS transistor is connected in parallel to each of the diode-connected MOS transistors.

10. The charge pump circuit according claim 2, wherein the charge pump circuit is integrated on a single substrate having a silicon on insulator (SOI) structure or a silicon on sapphire (SOS) structure.

11. A switch device comprising:
the charge pump circuit according to claim 2;
an oscillator configured to generate by oscillation the clock signal and the inverted clock signal that are respectively input to the clock signal input terminal and inverted clock signal input terminal of the charge pump circuit;
a switch including a plurality of switch input terminals and a plurality of switch output terminals and configured to realize a conducting state between any of the switch input terminals and any of the switch output terminals;
a decoder configured to receive a switch changing control signal for changing the conducting state of the switch and output a driver control signal obtained by decoding the switch changing control signal; and
a driver configured to use as a power supply voltage the output voltage output from the output terminal of the charge pump circuit, receive the driver control signal from the decoder, generate based on the driver control signal a switch control signal for controlling the conducting state of the switch, and output the switch control signal, wherein
the charge pump circuit, the oscillator, the decoder, the driver, and the switch are integrated on a single substrate having a silicon on insulator (SOI) structure or a silicon on sapphire (SOS) structure.

12. The charge pump circuit according to claim 4, wherein:
said at least two diodes are configured such that a plurality of rectifying circuits, each constituted by the two diode-connected MOS transistors connected in series, are connected;
among the plurality of rectifying circuits, each of the first-stage rectifying circuit and the last-stage rectifying circuit is constituted by the two diode-connected MOS transistors connected in series; and
the NMOS transistor or the PMOS transistor is connected in parallel to each of the diode-connected MOS transistors.

13. The charge pump circuit according to claim 5, wherein:
said at least two diodes are configured such that a plurality of rectifying circuits, each constituted by the two diode-connected MOS transistors connected in series, are connected;
among the plurality of rectifying circuits, each of the first-stage rectifying circuit and the last-stage rectifying circuit is constituted by the two diode-connected MOS transistors connected in series; and
the NMOS transistor or the PMOS transistor is connected in parallel to each of the diode-connected MOS transistors.

14. The charge pump circuit according to claim 6, wherein:
said at least two diodes are configured such that a plurality of rectifying circuits, each constituted by the two diode-connected MOS transistors connected in series, are connected;
among the plurality of rectifying circuits, each of the first-stage rectifying circuit and the last-stage rectifying circuit is constituted by the two diode-connected MOS transistors connected in series; and
the NMOS transistor or the PMOS transistor is connected in parallel to each of the diode-connected MOS transistors.

15. The charge pump circuit according to claim 7, wherein:
said at least two diodes are configured such that a plurality of rectifying circuits, each constituted by the two diode-connected MOS transistors connected in series, are connected;
among the plurality of rectifying circuits, each of the first-stage rectifying circuit and the last-stage rectifying circuit is constituted by the two diode-connected MOS transistors connected in series; and
the NMOS transistor or the PMOS transistor is connected in parallel to each of the diode-connected MOS transistors.

16. The charge pump circuit according to claim 8, wherein:
said at least two diodes are configured such that a plurality of rectifying circuits, each constituted by the two diode-connected MOS transistors connected in series, are connected;
among the plurality of rectifying circuits, each of the first-stage rectifying circuit and the last-stage rectifying circuit is constituted by the two diode-connected MOS transistors connected in series; and
the NMOS transistor or the PMOS transistor is connected in parallel to each of the diode-connected MOS transistors.
